(19) United States
(12) Patent Application Publication
(10) Pub. No.: US 2014/0325342 A1
(43) Pub. Date: Oct. 30, 2014

(54) SYSTEM FOR ASSISTING IN MODIFYING WEBSITES

(71) Applicant: MTU Aero Engines AG, (US)

(72) Inventor: Peter Wrenshall, Manchester (GB)

(21) Appl. No.: 14/354,041

(22) PCT Filed: Oct. 24, 2012
(86) PCT No.: PCT/EP2012/071023

§ 371 Date: Apr. 24, 2014

(30) Foreign Application Priority Data
Oct. 24, 2011 (GB) 1118283.9

(51) Int. Cl. G06F 17/24; G06F 17/22

(52) U.S. Cl. CPC G06F 17/248; G06F 17/2247
USPC 715/234

(57) ABSTRACT

A system that allows for persons having a disability or other illness which produces visual impairment or that impairs a person's fluency or comprehension or accuracy in being able to read comprising an HTML code in “clean” form and as opposed to existing “unclean” code. The use of the clean code allows users to identify the position on a screen of a particular feature. The clean code is always present at the same position on the screen.

### BACKGROUND OF THE INVENTION

This invention relates to a system which assists in presenting website information in a simplified context to make it more easily identifiable by disabled and elderly people.

Blind or partially sighted people, along with other people having other disabilities such as dyslexia, can at best find it difficult and in most cases impossible, to browse websites without the assistance of apparatus such as braille machines, screen readers and alike to help them. This may also be the case for many elderly people, in particular those who require assistance to read the content of a web page.

It is known that apparatus used by people with these types of disabilities and elderly people, rely on reading information directly from the HTML code that form web pages being viewed. A problem that arises from the use of this apparatus is they cannot do anything other than interpret what is presented to them. Therefore if the HTML code being presented is flawed in any way it will inevitably be the case that flaws lead to the apparatus misreading, skipping or confusing what is being presented. At its worst, users may not be able to read a website at all.

As, producing websites can take a considerable length of time to design and construct, in some instances, due to the lack of care taken to ensure that HTML code meets the correct conditions it is necessary to have a system that prevents such problems from arising.

It is an object of the present invention to provide a system, which overcomes or at least minimises the problems encountered by disabled or elderly people when using prior art systems.

### BRIEF SUMMARY OF THE INVENTION

Thus and in accordance with the present invention there is provided a system which presents website information identifiable by disabled or elderly users comprising a source from which a HTML code to be used to build up a web page can be accessed, a composition device which accesses content from such source and assembles such content into a web page for upload wherein said composition device comprises a template into which data can be added to form the basis of a web page, said template being of fixed characteristics which are replicated each time the template is utilized.

With such a system of the type of the present invention, it is possible to provide a template, which has fixed features thereto enabling a disabled or elderly person, to relate and rely on fixed references over a web page.

The invention will now be described further by way of example only and with reference to the drawings a single figure shows in diagrammatic form an embodiment of the system in the form of the present invention.

### BRIEF DESCRIPTION OF THE DRAWINGS

In the drawings which illustrate the best mode presently contemplated for carrying out the present invention:

FIG. 1 shows in diagrammatic form an embodiment of the system in the form of the present invention.

### DETAILED DESCRIPTION OF THE INVENTION

Referring now to the FIGURE, there is shown a block diagram indicating in diagrammatic form the operation of a system in accordance with the present invention.

Thus, the system accesses a websites database from which ‘raw’ code can be taken to build up a HTML web page for upload. The diagram contrasts the manner of operation of the prior art systems and the system in accordance with the present invention.

In the system of the invention, data is taken from the source and presented as “clean” HTML code. By “clean” is meant HTML code in which flaws have been removed in any suitable manner therefore eliminating the potential problems associated with prior art systems.

The system forming the embodiment of the present invention described is a system in which a change from where information is read. The system reads directly from a web sites database rather than the present system, which allows apparatus to read a websites HTML code “by looking in from the front”. The system is able to present a flawless version of a websites content, which each type of apparatus is able to read consistently and without interruption to the service provided. This new approach means that information can be presented without the flaws, which are often caused by incorrect HTML coding in current prior art systems.

In addition, when the system presents web pages to use, a template is used to ensure that the web pages are always laid out in the same configuration. Whilst such a system would be of limited interest to an able person it is has enormous benefits for disabled or elderly people as they recognise that everything they want to find is always available in the same place no matter which website is being visited. The uniqueness of the invention particularly when considering visually impaired or elderly users, is the layout of the systems web pages will always be the same and accessible to such persons and will comprise a system of relatively easy operation in comparison to prior art systems.

It will be appreciated that the experience had by able persons viewing web sites will be mirrored by the system providing a comparable experience to disabled and elderly users of the system.

It is of course to be understood that the invention is not intended to be restricted to the details of the above embodiment, which are described by way of example only.

What is claimed:

1. A system which prevents website information identifiable by disabled or elderly users comprising a source from which a HTML code to be used to build up a web page can be accessed, a composition device which accesses content from such source and assembles such content into a web page for upload wherein said composition device comprises a template into which data can be added to form the basis of a webpage, said template being of fixed characteristics which are replicated each time the template is utilised. With such a system of the type of the present invention, it is possible to provide a template, which has fixed features thereto enabling a disabled or elderly person, to relate and rely on fixed references over a web page.

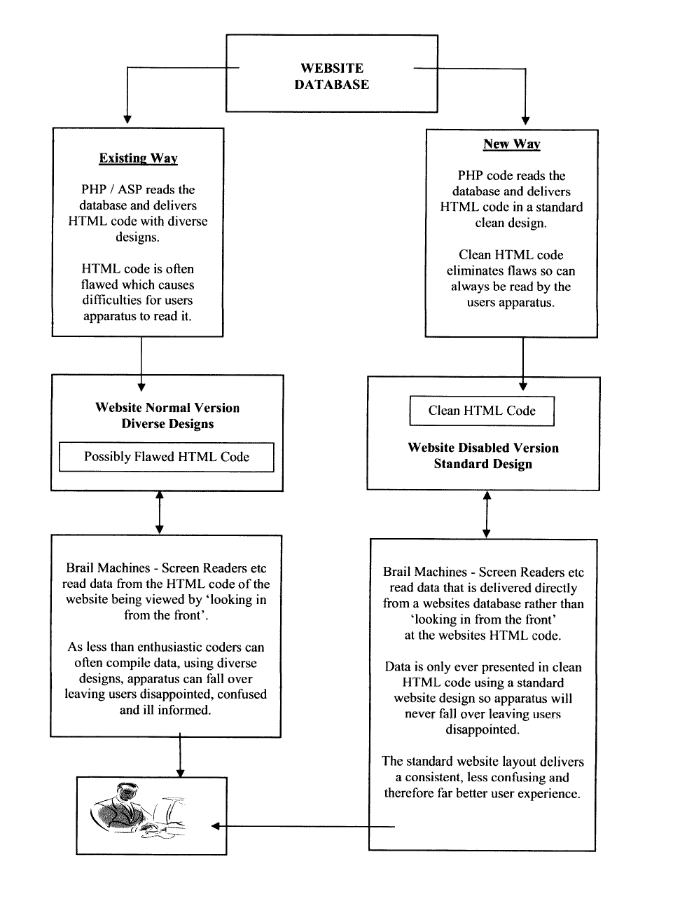

2. A system according to claim 1 substantially as herein before described with reference to FIG. 1 of the drawings.
